(19) United States
(12) Patent Application Publication
(10) Pub. No.: US 2022/0231445 A1
(43) Pub. Date: Jul. 21, 2022

(54) CONNECTOR

(71) Applicant: SUMITOMO WIRING SYSTEMS, LTD., Mie (JP)

(72) Inventors: Hiroto SAKAI, Mie (JP); Koyo TAKASAKI, Mie (JP)

(21) Appl. No.: 17/572,812

(22) Filed: Jan. 11, 2022

(30) Foreign Application Priority Data
Jan. 21, 2021 (JP) 2021-007744

(51) Int. Cl. H01R 13/436; H01R 13/422; H01R 13/506

(52) U.S. Cl. CPC H01R 13/4362; H01R 13/506; H01R 13/4223

(57) ABSTRACT

A connector includes a housing body provided with a plurality of cavities inside, a front mask to be mounted on a front surface of the housing body, and a lock arm extending rearward from a base end portion provided on the housing body. The front mask includes a locking portion to be locked to the base end portion.

### CROSS-REFERENCE TO RELATED APPLICATIONS

This application is based on and claims priority from Japanese Patent Application No. 2021-007744, filed on Jan. 21, 2021, with the Japan Patent Office, the disclosure of which is incorporated herein in their entireties by reference.

### TECHNICAL FIELD

The present disclosure relates to a connector.

### BACKGROUND

Conventionally, as described, for example, in Japanese Patent Laid-open Publication No. 2003-229196, a connector is known in which a front mask (described as a front holder in Japanese Patent Laid-open Publication No. 2003-229196) is mounted on the front surface of a housing body. The housing body accommodates two types of large and small terminal fittings. The front mask is mounted on a front side of a region where the small terminal fittings are accommodated, out of the front surface of the housing body. The front mask is mounted in a recess provided in the front surface of the housing body. Guide ribs and retaining projections are provided on both left and right side surfaces of the front mask. Guide grooves and retaining holes are formed in both left and right side surfaces of the recess. The front mask is guided to a proper mounting position by the guide ribs and the guide grooves. The front mask is held at the proper mounting position by the retaining projections and the retaining holes.

### SUMMARY

The connector as described above has tended to have a large width due to a locking structure of the front mask and the housing body.

Accordingly, the present disclosure aims to provide a connector capable of suppressing enlargement in a width direction.

The present disclosure is directed to a connector with a housing body provided with a plurality of cavities for accommodating terminal fittings, a front mask to be mounted on a front surface of the housing body, and a lock arm extending rearward from a base end portion provided on the housing body, the front mask including a locking portion to be locked to the base end portion.

According to the present disclosure, it is possible to provide a connector capable of suppressing enlargement in a width direction.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a connector according to an embodiment.

FIG. 2 is a front view showing the connector.

FIG. 3 is a section, corresponding to a cross-section along A-A of FIG. 2, showing the connector.

FIG. 4 is a partial enlarged section showing a front end part of the connector with a front mask removed.

FIG. 5 is a partial enlarged section showing the front end part of the connector with the front mask mounted.

FIG. 6 is a partial enlarged section showing a state of mounting the front mask on a housing body.

FIG. 7 is a front view showing the front mask.

FIG. 8 is a side view showing the front mask.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

(1) The connector of the present disclosure includes a housing body provided with a cavity for accommodating a terminal fitting, a front mask to be mounted on a front surface of the housing body, and a lock arm extending rearward from a base end portion fixed to the housing body, the front mask including a locking portion to be locked to the base end portion. According to this configuration, a width of the housing body can be made smaller as compared to the case where locking structures are provided on both left and right sides of the front mask. Therefore, enlargement in a width direction can be suppressed.

(2) Preferably, the locking portion of the front mask is resiliently deformable in a front-rear direction and exposed to outside of the housing body with the locking portion locked to the base end portion. According to this configuration, the enlargement of the housing body can be suppressed as compared to the case where a deflection space for the locking portion of the front mask is provided inside the housing body.

(3) The front mask may include a body portion to be put on the front surface of the housing body with the front mask mounted on the housing body, and a rear end of the locking portion may be located forward of a rear surface of the body portion. According to this configuration, the locking portion of the front mask is not in contact with the front surface of the housing body when the front mask is mounted by being moved in a direction parallel to the front surface of the housing body. Therefore, the front mask can be easily mounted on the housing body as compared to the case where the locking portion of the front mask contacts the front surface of the housing body in mounting the front mask on the housing body.

(4) The housing body may include a housing-side guide portion extending along the front surface of the housing body, and the front mask may include a mask-side guide portion configured to contact the housing-side guide portion from behind. According to this configuration, the front mask can be easily mounted on the housing body by bringing the mask-side guide portion into contact with the housing-side guide portion from behind and pushing the front mask in a moving direction.

(5) A recess may be formed in a front surface of the base end portion, and the locking portion may be fit into the recess with the locking portion locked to the base end portion. According to this configuration, since a projecting dimension of the locking portion from the housing body can be made smaller as compared to the case where the locking portion is not fit into the recess, the locking portion can be protected.

(6) The front mask may have a stopper surface, and the base end portion may have a first receiving surface to be locked to the locking portion and a second receiving surface oriented downward toward a side opposite to the first receiving surface and facing the stopper surface. According to this configuration, if the front mask is moved when being mounted on the housing body, the front mask can be stopped at a correct position by the stopper surface of the front mask and the second receiving surface of the base end portion. Since the first and second receiving surfaces are both provided on the base end portion of the lock arm, the enlargement of the housing body can be suppressed.

### Details of Embodiments of Present Disclosure

A specific example of a connector of the present disclosure is described below with reference to the drawings. Note that the present invention is not limited to these illustrations and is intended to be represented by claims and include all changes in the scope of claims and in the meaning and scope of equivalents.

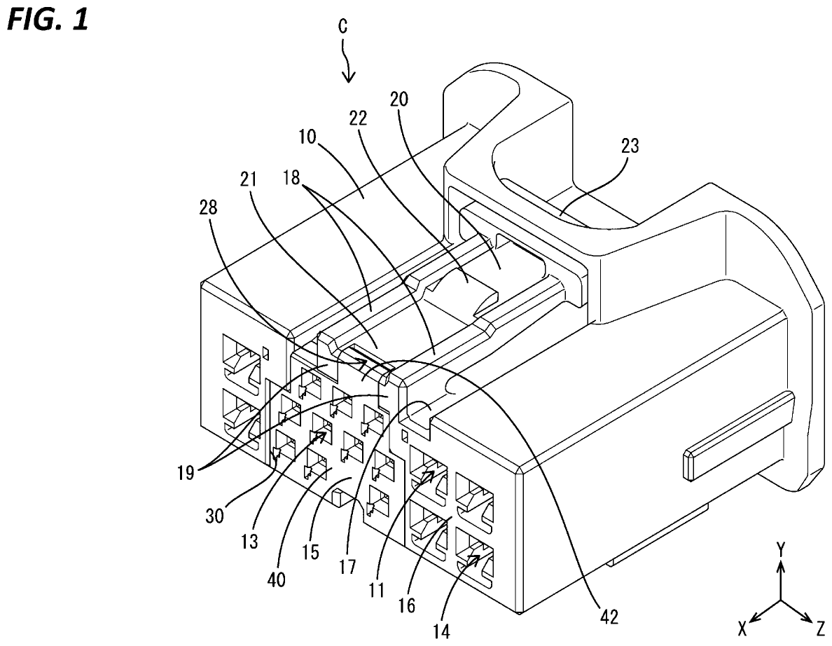

As shown in FIG. 1, a connector C includes a housing body 10 and a front mask 40. The front mask 40 is mounted on the front surface of the housing body 10. In the following description, in each constituent member, a forward direction side of an X axis of FIG. 1 is referred to as a front side, a negative direction side of the X axis of FIG. 1 is referred to as a rear side, a forward direction side of a Y axis of FIG. 1 is referred to as an upper side, a negative direction side of the Y axis of FIG. 1 is referred to as a lower side, a forward direction side of a Z axis of FIG. 1 is referred to as a right side, and a negative direction side of the Z axis of FIG. 1 is referred to as a left side.

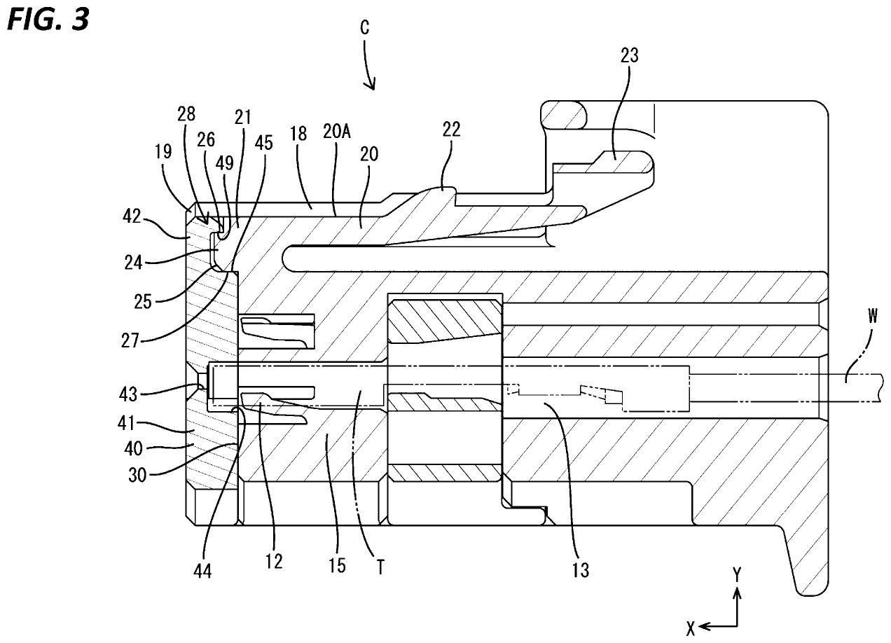

As shown in FIG. 1, the connector C is in the form of a rectangular block as a whole. A plurality of cavities 11 are provided inside the connector C. A plurality of the cavities 11 are arranged in each of a vertical direction and a lateral direction. Terminal fittings T fixed to end parts of wires W are accommodated into the cavities 11 (see FIG. 3). The terminal fittings T come in two small and large type. The terminal fitting T is inserted into each cavity 11 from behind. Each cavity 11 includes a locking lance 12. The locking lance 12 locks the terminal fitting T inserted to a proper position to retain the terminal fitting T. The locking lance 12 is cantilevered forward.

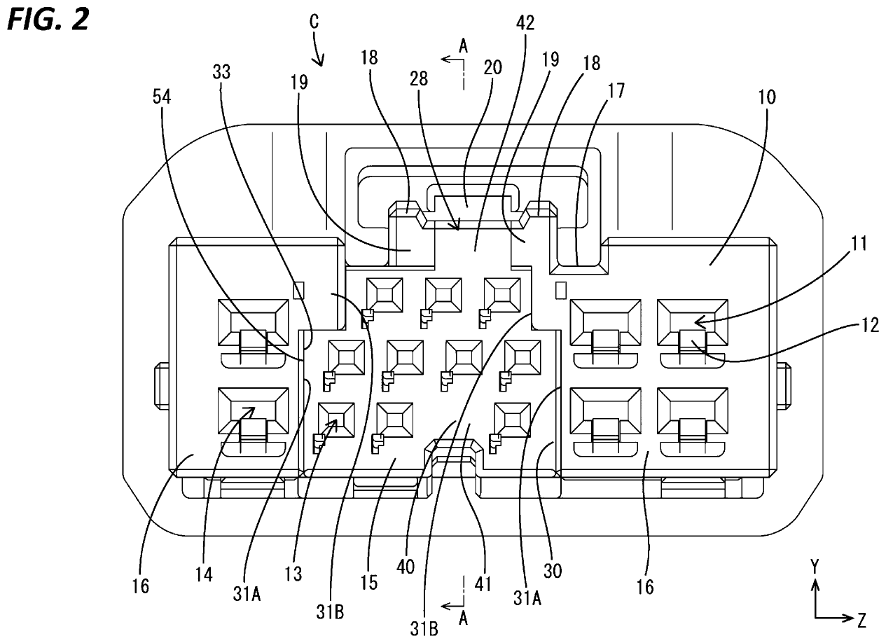

As shown in FIG. 2, the cavities 11 include first cavities 13 and second cavities 14. The first cavities 13 are smaller than the second cavities 14. The small terminal fittings T are accommodated into the first cavities 13. The large terminal fittings T are accommodated into the second cavities 14.

The connector C has a first region 15 and second regions 16. The first cavities 13 are provided in the first region 15. The second cavities 14 are provided in the second regions 16. The first region 15 is arranged in a laterally central part of the connector C. The second regions 16 are arranged on both left and right sides of the first region 15.

As shown in FIG. 2, the front surface of the connector C has a rectangular shape long in the lateral direction. The front surface of the connector C is a connection surface to an unillustrated mating connector. The front surface of the front mask 40 and that of the housing body 10 in the second regions 16 are aligned in a front-rear direction. The lower surface of the front mask 40 and that of the housing body 10 are aligned in the vertical direction.

As shown in FIG. 1, a lock arm 20 is provided on the upper surface of the housing body 10. The lock arm 20 is arranged in a lateral center of the housing body 10. The lock arm 20 is provided substantially in a center of a recessed portion 17 in the upper surface of the housing body 10.

The lock arm 20 extends rearward from a base end portion 21 fixed to the housing body 10. The base end portion 21 is located in the lateral center of the housing body 10. A rear end part of the lock arm 20 is a free end part. A lock projection 22 to be locked to the mating connector is provided on an upper surface 20A of the lock arm 20. An operating portion 23 is provided in a rear end part of the lock arm 20. Locking to the mating connector is released by pressing the operating portion 23 downward.

Ribs 18 are provided on both left and right ends of the lock arm 20. The ribs 18 extend long in the front-rear direction along both left and right edges of the lock arm 20. The left and right ribs 18 are parallel. Parallel does not mean parallel in a strict sense, but means that two extend side by side. Front end parts of the ribs 18 project upward from the bottom surface of the recessed portion 17. The upper surfaces of the ribs 18 are located above the upper surface 20A of the lock arm 20 except the lock projection 22 and the operating portion 23 (see FIG. 3).

As shown in FIG. 3, the base end portion 21 is arranged in a front end part of the housing body 10. The base end portion 21 is provided with a locking step portion 24. The upper surface of the locking step portion 24 is located below the upper surface 20A of the lock arm 20. A lower inclined surface 25 is formed on the lower surface of the locking step portion 24. The lower inclined surface 25 contacts a later-described locking portion 42 of the front mask 40 to guide the resilient deformation of the locking portion 42 in mounting the front mask 40 on the housing body 10.

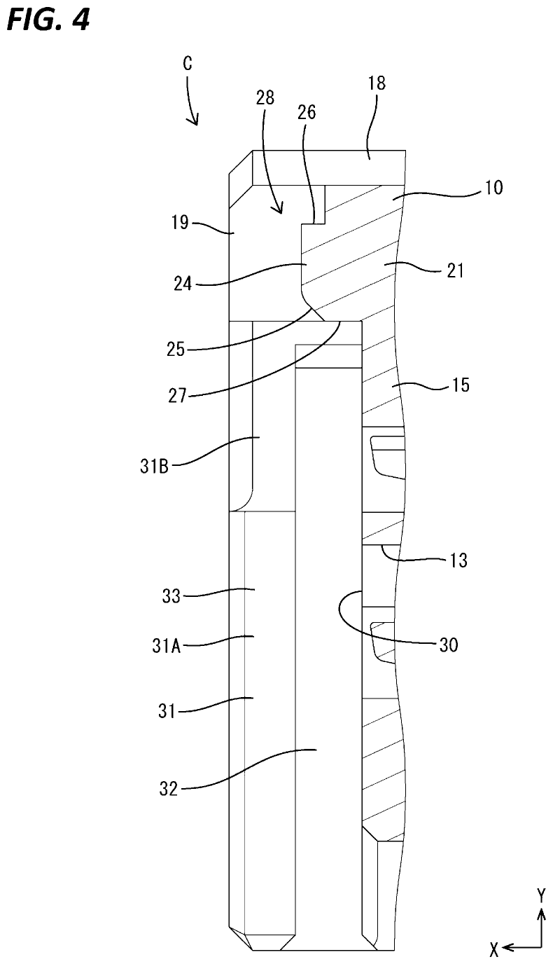

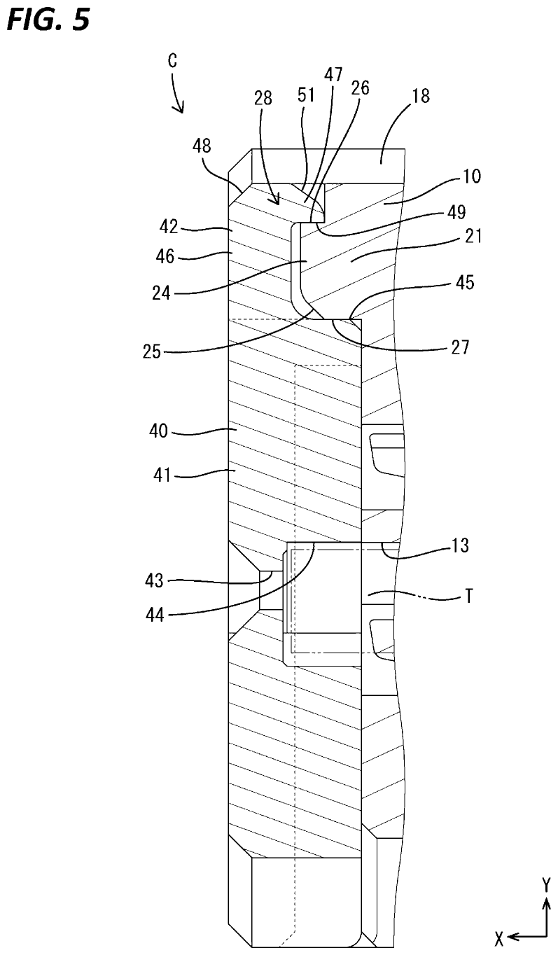

As shown in FIG. 4, the locking step portion 24 has a first receiving surface 26 and a second receiving surface 27. The locking portion 42 of the front mask 40 is locked to the first receiving surface 26 (see FIG. 5). The first receiving surface 26 is formed on the upper surface of the locking step portion 24.

The second receiving surface 27 is facing a stopper surface 45 of the front mask 40 (see FIG. 5). The second receiving surface 27 is formed on the lower surface (surface opposite to the first receiving surface 26) of the locking step portion 24. The second receiving surface 27 is provided behind the lower inclined surface 25.

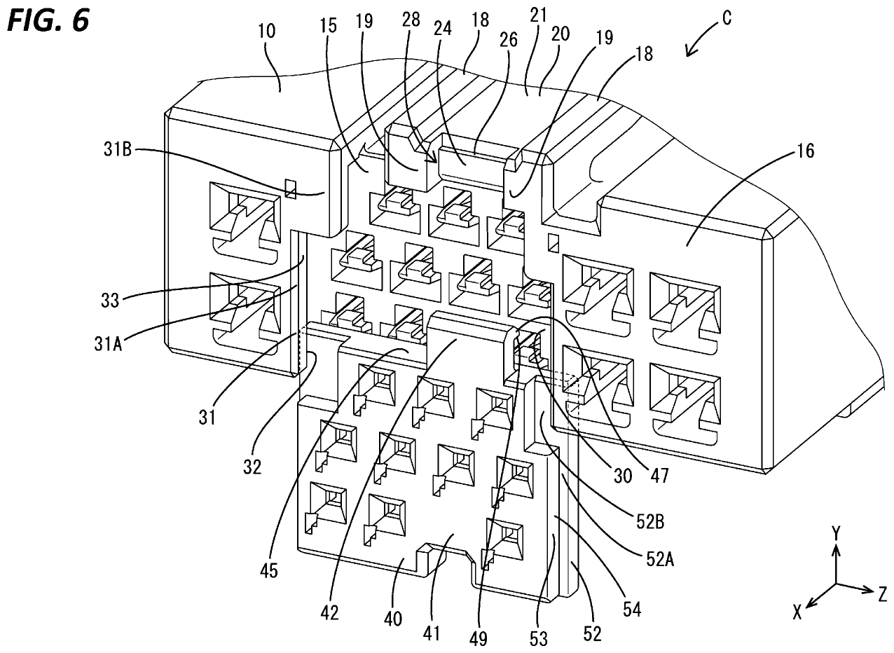

As shown in FIG. 6, protection walls 19 are provided on both left and right sides of the locking step portion 24. The left and right protection walls 19 are connected to the front end parts of the left and right ribs 18. The left and right protection walls 19 project further forward than the front surface of the locking step portion 24. The front surfaces of the protection walls 19 and that of the housing body 10 in the second regions 16 are aligned in the front-rear direction. The upper surfaces of the protection walls 19 are located above the first receiving surface 26 of the locking step portion 24. The lower surfaces of the protection walls 19 constitute parts of the second receiving surface 27.

As shown in FIG. 6, a recess 28 is formed in front of the locking step portion 24. The recess 28 is recessed rearward from the front surfaces of the protection walls 19. Both upper and lower sides of the recess 28 are open.

As shown in FIGS. 2 and 6, a fitting recess 30 is provided in the front surface of the housing body 10. The front mask 40 is fit into the fitting recess 30. Front and lower sides of the fitting recess 30 are open. An upper side of the fitting recess 30 communicates with the recess 28 except a part closed by the second receiving surface 27. The front mask 40 is fit into the fitting recess 30 from below. In mounting the front mask 20 on the housing body 10, the front surface of the front mask 40 moves in the vertical direction (direction parallel to the front surface of the housing body 10) along the front surface of the housing body 10.

The fitting recess 30 is formed in the front surface of the housing body 10 in the first region 15. By forming the fitting recess 30, the front surface of the housing body 10 in the first region 15 is located behind the front surface of the housing body 10 in the second regions 16.

As shown in FIG. 2, the fitting recess 30 is provided at a position near one side (left side) in the lateral direction. A lateral center position of the fitting recess 30 is shifted leftward from that of the housing body 10. Thus, the base end portion 21 of the lock arm 20 is arranged to the right of the lateral center position of the fitting recess 30.

As shown in FIG. 6, the housing body 10 includes housing-side guide portions 31. The housing-side guide portions 31 are provided on both left and right sides of the fitting recess 30. The housing-side guide portions 31 extend in the vertical direction along the front surface of the housing body 10 in the second regions 16.

The housing-side guide portions 31 are facing away from the front surface of the housing body 10 in the first region 15. Groove portions 32 are formed between the housing-side guide portions 31 and the front surface of the housing body 10 in the first region 15 (see FIG. 4). The lower ends of the groove portions 32 serve as entrances for mask-side guide portions 52. The housing-side guide portions 31 and the groove portions 32 have housing-side guide surfaces 33. The housing-side guide surfaces 33 extend in the vertical direction.

As shown in FIG. 2, the housing-side guide portion 31 includes a lower guide portion 31A and an upper guide portion 31B. The lower guide portion 31A has a larger vertical dimension than the upper guide portion 31B. The upper guide portion 31B has a larger lateral dimension than the lower guide portion 31A. In this way, the front mask 40 can be stopped in contact with the lower surfaces of the upper guide portions 31B.

The front mask 40 includes a body portion 41 and the locking portion 42. The body portion 41 is put on the front surface of the housing body 10 in the first region 15 to cover front sides of the locking lances 12 as shown in FIG. 3 with the front mask 40 mounted on the housing body 10. The locking portion 42 is locked to the base end portion 21.

As shown in FIG. 5, the body portion 41 is formed with tab insertion openings 43 and front end accommodating portions 44. The tab insertion openings 43 and the front end accommodating portions 44 are arranged in front of the first cavities 13 with the front mask 40 mounted on the housing body 10. Front end parts of the small terminal fittings T are accommodated into the front end accommodating portions 44. The small terminal fittings T are stopped in contact with the front surfaces (back surfaces) of the front end accommodating portions 44.

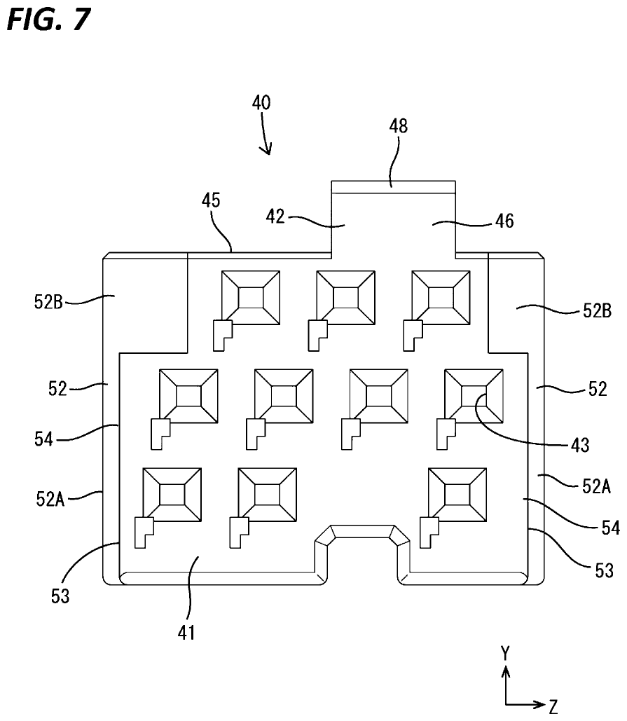

As shown in FIG. 5, the body portion 41 has the stopper surface 45. The stopper surface 45 is provided on the upper surface of the body portion 41 (front side in a moving direction of the front mask 40). As shown in FIG. 7, the stopper surface 45 extends in the lateral direction up to both left and right ends of the body portion 41.

As shown in FIG. 7, the body portion 41 has a rectangular shape when viewed from front. The body portion 41 is in the form of a thick plate along the front surface of the housing body 10 in the first region 15. The body portion 41 is closely fittable into the fitting recess 30 (see FIG. 6). That is, a vertical dimension, a width (lateral dimension) and a thickness (front-rear dimension) of the body portion 41 are equal to those of the fitting recess 30.

As shown in FIG. 7, the locking portion 42 is provided on the upper surface of the body portion 41. The locking portion 42 stands upward from the upper surface of the body portion 41. The locking portion 42 is arranged at a position closer to one side (right side) than a lateral center of the body portion 41.

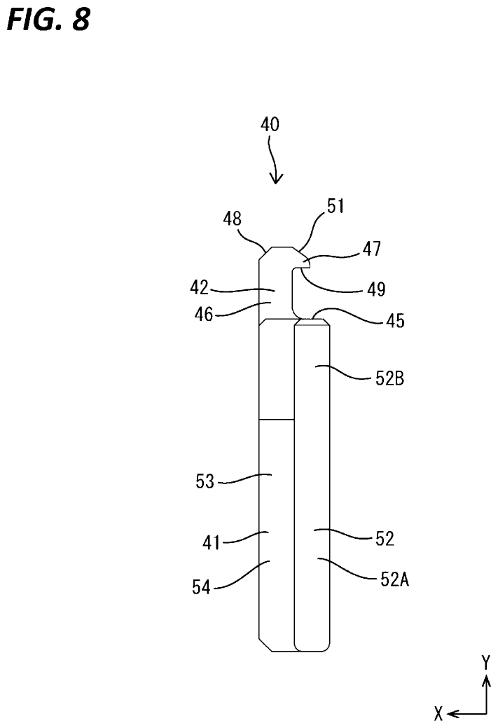

As shown in FIG. 8, the locking portion 42 includes an extending portion 46 and a locking projection 47. The extending portion 46 is in the form of a wall projecting upward from the upper surface of the body portion 41. The extending portion 46 is resiliently deformable in the front-rear direction. The extending portion 46 is arranged on a front side of the upper surface of the body portion 41. The stopper surface 45 is formed behind the extending portion 46 on the upper surface of the body portion 41. A front inclined surface 48 is formed on the upper surface of the extending portion 46. As shown in FIG. 5, the front inclined surface 48 is located on the front end of the connector C with the front mask 40 mounted on the housing body 10. The front inclined surface 48 guides connection to the unillustrated mating connector.

As shown in FIG. 8, the locking projection 47 is provided on an upper end part of the extending portion 46. The locking projection 47 projects rearward from the rear surface of the extending portion 46. The rear end of the locking projection 47 (rear end of the locking portion 42) is located forward of the rear surface of the body portion 41. A width (lateral dimension) of a locking surface 49 is equal to that of the extending portion 46.

As shown in FIG. 5, the locking projection 47 has the locking surface 49 to be locked to the first receiving surface 26. The locking surface 49 is provided on the lower surface of the locking projection 47. The locking surface 49 is facing the stopper surface 45 in the vertical direction. The upper surface of the locking projection 47 has a rear inclined surface 51. The rear inclined surface 51 contacts the lower surface of the locking step portion 24 to guide the resilient deformation of the locking portion 42 in mounting the front mask 40 on the housing body 10. An upper end part of the locking portion 42 is tapered by the front inclined surface 48 of the extending portion 46 and the rear inclined surface 51 of the locking projection 47.

As shown in FIG. 6, the front mask 40 includes the mask-side guide portions 52. The mask-side guide portions 52 are positioned behind the housing-side guide portions 31. The mask-side guide portions 52 are movable in the vertical direction with respect to the housing-side guide portions 31 with the mask-side guide portions 52 inserted in the housing-side guide portions 31.

As shown in FIG. 7, the mask-side guide portions 52 are provided on both left and right sides of the body portion 41. The mask-side guide portions 52 extend in the vertical direction. The mask-side guide portions 52 are formed on a rear surface side of the body portion 41 (see FIG. 8). Stepped recesses 53 are formed in front of the mask-side guide portions 52. As shown in FIG. 6, the stepped recesses 53 are so shaped that the housing-side guide portions 31 are fit thereinto.

The mask-side guide portions 52 and the stepped recesses 53 have mask-side guide surfaces 54. The mask-side guide surfaces 54 extend in the vertical direction. The mask-side guide surfaces 54 contact the housing-side guide surfaces 33. In this way, the front mask 40 is efficiently guided when moving to be mounted on the housing body 10.

As shown in FIG. 7, the mask-side guide portion 52 includes a lower guide portion 52A and an upper guide portion 52B. The lower guide portion 52A has a larger vertical dimension than the upper guide portion 52B. The lower guide portion 52A has a smaller lateral dimension than the upper guide portion 52B. The upper guide portion 52B is located behind the upper guide portion 31B of the housing-side guide portion 31 (see FIG. 6). The lower guide portion 52A is positioned behind the lower guide portion 31A of the housing-side guide portion 31.

Next, an example of an operation of mounting the front mask 40 on the housing body 10 is described. As shown in FIG. 6, upper end parts of the mask-side guide portions 52 are inserted into the lower ends of the groove portions 32 of the housing body 10. The housing-side guide portions 31 and the mask-side guide portions 52 come into contact with each other in the front-rear direction. In this way, the front mask 40 is restricted from moving from the fitting recess 30 in the front-rear direction and lateral direction.

Subsequently, the front mask 40 is moved upward. The front mask 40 is guided upward toward a proper mounting position by the contact of the mask-side guide surfaces 54 and the housing-side guide surfaces 33. When the front mask 40 moves, the rear end of the locking projection 47 is not in contact with the front surface of the housing body 10. When the front mask 40 moves, the rear surface of the body portion 41 is proximate to or in contact with the front surface of the housing body 10.

Eventually, the rear inclined surface 51 of the locking portion 42 contacts the lower inclined surface 52 of the locking step portion 24 from below. Subsequently, the locking portion 42 is resiliently deformed forward by the inclination of the rear and lower inclined surfaces 51, 52. The locking projection 47 rides on a front side of the locking step portion 24.

Thereafter, as shown in FIG. 5, the front mask 40 reaches the proper mounting position. The stopper surface 45 of the front mask 40 contacts the second receiving surface 27. In this way, the front mask 40 is restricted from moving upward beyond the proper mounting position. The locking projection 47 rides over the locking step portion 24. The locking portion 42 is displaced forward with a resilient force. Thereafter, the locking portion 42 resiliently returns (returns to a natural state) and is fit into the recess 28 (see FIG. 1). In the state fit in the recess 28, the locking portion 42 is exposed to the outside of the housing body 10. The upper surface of the locking portion 42 fit in the recess 28 is located below the upper surfaces of the protection walls 19 (see FIG. 3). The locking surface 49 is locked to the first receiving surface 26. The locking portion 42 of the front mask 40 is locked to the base end portion 21. In this way, the front mask 40 is restricted from moving downward (being separated) from the proper mounting position. In the above way, the operation of mounting the front mask 40 on the housing body 10 is completed.

Next, functions and effects of the embodiment configured as described above are described. The connector C includes the housing body 10, the front mask 40 and the lock arm 20. The plurality of cavities 11 are provided inside the housing body 10. The front mask 40 is mounted on the front surface of the housing body 10. The lock arm 20 extends rearward from the base end portion 21 fixed to the housing body 10. The front mask 40 includes the locking portion 42 to be locked to the base end portion 21. According to this configuration, the width of the housing body 10 can be made smaller as compared to the case where locking structures are provided on both left and right sides of the front mask 40. Further, the base end portion 21 of the lock arm 20 can be utilized as a locking part for the front mask 40. Therefore, the enlargement of the connector C in the width direction can be suppressed.

The locking portion 42 of the front mask 40 is resiliently deformable in the front-rear direction. The locking portion 42 is exposed to the outside of the housing body 10 with the locking portion 42 locked to the base end portion 21. According to this configuration, the enlargement of the housing body 10 can be suppressed as compared to the case where a deflection space for the locking portion 42 of the front mask 40 is provided inside the housing body 10. Further, a locked state of the locking portion 42 of the front mask 40 and the base end portion 21 can be visually confirmed.

The front mask 40 includes the body portion 41 to be put on the front surface of the housing body 10 with the front mask 40 mounted on the housing body 10. A moving direction of the front mask 40 in mounting the front mask 40 on the housing body 10 is a direction parallel to the front surface of the housing body 10. The rear end of the locking portion 42 is located forward of the rear surface of the body portion 41. According to this configuration, the locking portion 42 of the front mask 40 is not in contact with the front surface of the housing body 10 in mounting the front mask 40 on the housing body 10. Therefore, the front mask 40 can be easily mounted on the housing body 10 as compared to the case where the locking portion 42 of the front mask 40 is in contact with the front surface of the housing body 10 in mounting the front mask 40 on the housing body 10.

The housing body 10 includes the housing-side guide portions 31. The front mask 40 includes the mask-side guide portions 52. The mask-side guide portions 52 are located behind the housing-side guide portions 31 and movable in the vertical direction with respect to the housing-side guide portions 31. According to this configuration, the front mask 40 can be easily mounted on the housing body 10 by inserting the mask-side guide portions 52 behind the housing-side guide portions 31 and pushing the front mask 40 in the moving direction.

The base end portion 21 is formed with the recess 28. The locking portion 42 is fit into the recess 28 with the locking portion 42 locked to the base end portion 21. According to this configuration, a projecting dimension of the locking portion 42 from the housing body 10 can be made smaller as compared to the case where the locking portion 42 is not fit into the recess 28. Thus, the locking portion 42 can be protected from contact with external matters and the like.

The front mask 40 has the stopper surface 45. The base end portion 21 has the first and second receiving surfaces 26, 27. The locking portion 42 is locked to the first receiving surface 26. The second receiving surface 27 is oriented toward a side opposite to the first receiving surface 26 and facing the stopper surface 45. According to this configuration, if the front mask 40 moves in mounting the front mask 40 on the housing body 10, the front mask 40 can be stopped at a correct position by the stopper surface 45 of the front mask 40 and the second receiving surface 27 of the base end portion 21. Since the first and second receiving surfaces 26, 27 are both provided on the base end portion 21 of the lock arm 20, the enlargement of the housing body 10 can be suppressed as compared to the case where receiving surfaces are provided on left and right sides.

### Other Embodiments of Present Disclosure

The embodiment disclosed this time should be considered illustrative in all aspects, rather than restrictive.

In the case of the above embodiment, the fitting recess 30 is provided in the front surface of the housing body 10. As another embodiment, a fitting recess may not be provided in the front surface of a housing body. In such a case, housing-side guide portions may be provided to project on the front surface of the housing body.

In the case of the above embodiment, the fitting recess 30 is provided at the position near the left side of the housing body 10 in the lateral direction. As another embodiment, a fitting recess may be formed in a lateral center of a housing body or may be formed at a position near a right side.

In the case of the above embodiment, the front mask 40 is mounted on the housing body 10 by moving in parallel to the front surface of the housing body 10. As another embodiment, the front mask 40 may be mounted on the housing body 10 by being brought closer to the front surface of the housing body 10 from front.

In the case of the above embodiment, the base end portion 21 is formed with the recess 28. As another embodiment, a recess may not be formed in a base end portion.

In the case of the above embodiment, the front mask 40 covers the front sides of the locking lances 12. As another embodiment, a front mask may have a retainer function of limiting the deflection of locking lances.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a housing body provided with a cavity for accommodating a terminal fitting;
a front mask to be mounted on a front surface of the housing body; and
a lock arm extending rearward from a base end portion provided on the housing body,
the front mask including a locking portion to be locked to the base end portion.

2. The connector of claim 1, wherein the locking portion of the front mask is resiliently deformable in a front-rear direction and exposed to outside of the housing body with the locking portion locked to the base end portion.

3. The connector of claim 1, wherein:
the front mask includes a body portion to be put on the front surface of the housing body with the front mask mounted on the housing body, and
a rear end of the locking portion is located forward of a rear surface of the body portion.

4. The connector of claim 1, wherein:
the housing body includes a housing-side guide portion extending along the front surface of the housing body, and
the front mask includes a mask-side guide portion configured to contact the housing-side guide portion from behind.

5. The connector of claim 1, wherein:
a recess is formed in a front surface of the base end portion, and
the locking portion is fit into the recess with the locking portion locked to the base end portion.

6. The connector of claim 1, wherein:
the front mask has a stopper surface, and
the base end portion has a first receiving surface to be locked to the locking portion and a second receiving surface oriented downward toward a side opposite to the first receiving surface and facing the stopper surface.
